(19) United States
(12) Patent Application Publication
(10) Pub. No.: US 2010/0304908 A1
(43) Pub. Date: Dec. 2, 2010

(54) SHAFT OF BELT-TYPE CONTINUOUSLY VARIABLE TRANSMISSION, STATIONARY SHEAVE HALF FOR CONTINUOUSLY VARIABLE TRANSMISSION, METHOD FOR PRODUCTION THEREOF, AND CONTINUOUSLY VARIABLE TRANSMISSION

(75) Inventors: Daisuke Kikukawa, Aichi-ken (JP); Takashi Suzumura, Aichi-ken (JP); Toshihiko Kamiya, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA

(21) Appl. No.: 12/677,953

(22) PCT Filed: Oct. 23, 2008
(86) PCT No.: PCT/IB08/02833

§ 371 Date: Mar. 12, 2010

(30) Foreign Application Priority Data
Oct. 25, 2007 (JP) 2007-277811

(51) Int. Cl. F16H 55/36; B23P 11/00

(52) U.S. Cl. 474/166; 29/428

(57) ABSTRACT

The position of a ball bearing (18) on a shaft (16) may be fixed, press fitting a sheave portion (10) onto the shaft (16) and sandwiching the ball bearing (18) between a flange (16a) and the sheave portion (10). Thus, the axial dimension of a stationary sheave half (4) for a continuously variable transmission may be reduced. Because one end (10c) of the sheave portion (10) is in contact with the ball bearing (18), thrust force from the sheave portion (10) is transmitted via the ball bearing (18) to the flange (16a), which will not loosen and, thereby, the structural integrity of the stationary sheave half (4) is maintained.

### BACKGROUND OF THE INVENTION

1. Field of the Invention

The present invention relates to a stationary sheave half for a continuously variable transmission. More specifically, the present invention relates to a stationary sheave half formed by integrating a shaft and the sheave portion together with a bearing.

2. Description of the Related Art

To obtain a sheave (pulley) of a continuously variable transmission, a sheave portion needs to be formed on a shaft. However, if these are integrally formed by casting or the like, the manufacturability is generally poor because the outside diameter of the sheave portion and the axial dimension of the shaft are both large.

However, a method in which a sheave portion is formed as a separate part and integrated with a shaft is known (for example, see Japanese Patent Application Publication No. 2005-69253 (JP-A-2005-69253) (FIG. 1) and Japanese Patent Application Publication No. 2003-83424 (JP-A-2003-83424) (FIGS. 1 to 4)). In JP-A-2005-69253 (FIG. 1), a separate sheave portion is fixed to a shaft by interlocking projections and recesses, allowing to rotate synchronously. In JP-A-2003-83424 (FIGS. 1 to 4), a separate sheave portion is integrated with a shaft by friction pressure welding.

When the sheave portion and shaft are formed as separate parts, positioning and fixing of the sheave portion on the shaft is necessary, and, in addition, positioning and fixing of a bearing on the shaft is necessary to ensure that the shaft rotates with its axial position fixed.

When the configuration of JP-A-2005-69253 (FIG. 1) is adopted, a sheave portion C1 is fitted on one side of a large-diameter flange D1 formed on an outer periphery of a shaft S1 by means of projections K1 as shown in FIG. 5A, whereby the sheave portion C1 is axially positioned and fixed at the flange D1. Then, a ball bearing B1 is brought into contact with the other side of the flange D1 to determine the axial position of the entire stationary sheave half including the shaft S1 and the sheave portion C1. The fixing of the ball bearing B1 is achieved by tightening a nut N1 onto a threaded portion E1 formed at an end of the shaft S1. As a result, the stationary sheave half, the axial position of which is fixed, is rotatably supported in a case F1 of the continuously variable transmission.

However, in the configuration shown in FIG. 5A, the overall axial dimension of the stationary sheave half tends to increase because the flange D1 and the threaded portion E1 have to be formed in the axial direction of the shaft S1.

One possible modification of the stationary sheave half is shown in FIG. 5B. In this configuration, a large-diameter flange D2 is formed on a shaft S2 on the side opposite the flange D1 in FIG. 5A. Therefore, a sheave portion C2 is mounted from the threaded portion E2 side, axially positioned by the flange D2, and fitted on the shaft S2 by means of projections K2. Then, a ball bearing B2 is fitted with the sheave portion C2 in contact with the flange D2, and a nut N2 is threaded onto the threaded portion E2 to fix the ball bearing B2 on the shaft S2. As a result, the axial position of the ball bearing B2 is fixed in a case F2 of a continuously variable transmission, and the stationary sheave half is rotatably supported.

However, the force exerted on the sheave face P1 from the belt when the continuously variable transmission is being driven is transmitted from the sheave portion C1 to the flange D1, as shown in FIG. 5A. In contrast, the force exerted on the sheave face P2 from the belt is transmitted from the sheave portion C2 to the nut N2 via the ball bearing B2, as shown in FIG. 5B. Thus, the nut N2 may loosen to the point where the structural integrity of the stationary sheave half cannot be maintained.

The shaft of JP-A-2003-83424 (FIGS. 1 to 4) has better manufacturability than a shaft having an integrally-formed sheave portion. However, a flange portion with a relatively large diameter needs to be formed integrally with the shaft, and therefore the shaft has poorer manufacturability than a shaft without a flange portion. In addition, because a bearing has to be provided in this configuration as in the case with the configuration of JP-A-2005-69253 (FIG. 1), that is, as shown in FIG. 5A, the fact still remains that the overall axial dimension of the stationary sheave half tends to increase.

### SUMMARY OF THE INVENTION

The present invention provides a technique to reduce the axial dimension of a stationary sheave half for a continuously variable transmission which is produced by forming a shaft and a sheave portion separately and integrating the shaft and sheave portion together with a bearing and to integrate the shaft and sheave portion of the stationary sheave half firmly.

A first aspect of the present invention relates to the shaft of a belt-type continuously variable transmission, which is formed separately from a sheave portion and then integrated with the sheave portion together with a bearing to form a stationary sheave half. The shaft of a belt-type continuously variable transmission includes: a flange formed at one end of the shaft which has a larger diameter than the other part of the shaft; a bearing fitting portion adjoins the flange that receives the bearing thereon; and a sheave portion fixing portion, adjoins the bearing fitting portion, that fixes the sheave portion at a center hole thereof.

In the above aspect, the axial position of the bearing fitted on the bearing fitting portion may be determined by the flange. In addition, the fixing of the position of the bearing can be achieved, when the shaft and the sheave portion are integrated, by fixing the fixing sheave portion on the sheave portion fixing portion with the bearing sandwiched between the flange and the sheave portion.

As described above, because the shaft does not have a threaded portion, but instead has a flange, the bearing may be fixed on the shaft when integrated with the shaft and the sheave portion, thereby reducing the axial dimension of the resulting stationary sheave half. In addition, even if thrust force exerted on the sheave portion is applied to the bearing, the flange will not loosen, unlike nuts, because the flange lies, instead of the nut, in the direction in which the thrust force acts. Therefore, the structural integrity of the stationary sheave half including the shaft may be maintained.

In the above aspect, the sheave portion may be fixed to the sheave portion fixing portion by press-fitting.

The fixing of the sheave portion on the sheave portion fixing portion of the shaft may be achieved by press-fitting. The sheave portion may be fixed in contact with the bearing on the sheave portion fixing portion as described above. Thus, the stationary sheave half may therefore be produced easily.

In the above aspect, the sheave portion may be fixed to the sheave portion fixing portion by press-fitting tooth flanks of the shaft, which are formed larger than tooth flanks of the sheave portion, into the sheave portion.

The fixing of the sheave portion on the sheave portion fixing portion of the shaft may be achieved by press-fitting tooth flanks of the shaft into the sheave portion. The sheave portion can be fixed in contact with the bearing on the sheave portion fixing portion as described above, and the stationary sheave half may therefore be produced easily. Because the sheave portion is fixed to the shaft by press-fitting the tooth flanks of the shaft into the sheave portion, the sheave portion is secured firmly enough on the shaft to ensure sufficient transmission of torque between the sheave portion and the shaft.

In the above aspect, the sheave portion may be welded to the sheave portion fixing portion. Because the sheave portion may be welded to the sheave portion fixing portion of the shaft, the sheave portion may be fixed in contact with the bearing on the sheave portion fixing portion as described above, and the stationary sheave half may therefore be produced easily.

In the above aspect, the sheave portion fixing portion may be a portion on which the sheave portion is fixed by spline fitting.

In the above aspect, the bearing may abut against the flange.

In the above aspect, the bearing may be a ball bearing.

If a ball bearing is used as the bearing, the shaft may be rotatably supported with its axial position fixed in the continuously variable transmission.

In the above aspect, the shaft may constitute a secondary sheave of a continuously variable transmission.

The shaft can be used as a shaft of a secondary sheave, in particular. Therefore, the axial dimension of the secondary sheave may be reduced, and the structural integrity of the stationary sheave half of a secondary sheave is maintained.

A second aspect of the present invention relates to a stationary sheave half for a continuously variable transmission. The stationary sheave half includes: the shaft of a belt-type continuously variable transmission according to the first aspect; a bearing that adjoins the flange of the shaft on the bearing fitting portion of the shaft; and a sheave portion fixed on the sheave portion fixing portion of the shaft while an end thereof, in the direction of thrust force from the sheave face, in contact with the bearing.

Because the stationary sheave half for a continuously variable transmission is constituted as described above, the bearing is positioned between the flange and the sheave portion. That is, because a flange is utilized to integrate the shaft and the sheave portion and to fix the bearing on the shaft, the axial dimension of the stationary sheave half is small. In addition, because the flange lies via the bearing in the direction in which the thrust force is exerted from the sheave portion, the structural integrity as a stationary sheave half is maintained.

A third aspect of the present invention relates to a method for producing a stationary sheave half for a continuously variable transmission. The method includes: sliding the bearing and the sheave portion sequentially onto the shaft according to the first aspect from the end opposite from the flange; fitting the bearing in contact with the flange on the bearing fitting portion; and fixing the sheave portion on the sheave portion fixing portion while an end thereof, in the direction which the thrust force acts from the sheave face, in contact with the bearing.

According to the above procedure the sheave portion, together with the bearing, may be easily integrated with the shaft, which is formed separately. Therefore, both the shaft for a belt-type continuously variable transmission and the sheave portion may be easily produced and easily integrated with each other. As a result, the stationary sheave half for a continuously variable transmission with a high manufacturability is realized.

The thus formed stationary sheave half for a continuously variable transmission has a small axial dimension because a flange is utilized to integrate the shaft, the bearing and the sheave portion. In addition, because the flange, which will not loosen like nuts may, lies via the bearing in the direction in which the thrust force is exerted from the sheave portion, the structural integrity as a stationary sheave half for a continuously variable transmission is maintained.

A fourth aspect of the present invention relates to a continuously variable transmission. The continuously variable transmission incorporates the stationary sheave half for a continuously variable transmission according to the second aspect.

The continuously variable transmission incorporating the stationary sheave half according to the above aspect may reduce in overall length for the reasons described before, and therefore contributes to the reduction of size and weight of a vehicle to which it is applied.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a vertical cross-sectional view illustrating the configuration of a principal part of a secondary sheave of a continuously variable transmission according to an embodiment.

FIG. 2 is a vertical cross-sectional view of a stationary sheave half for a continuously variable transmission according to the embodiment.

FIG. 3 is a vertical cross-sectional view illustrating the components of the stationary sheave half for a continuously variable transmission in an exploded manner.

FIG. 4 is an explanatory view showing a process for the production of the stationary sheave half for a continuously variable transmission.

FIG. 5 is a vertical cross-sectional view of essential parts of a related art and a configuration similar thereto.

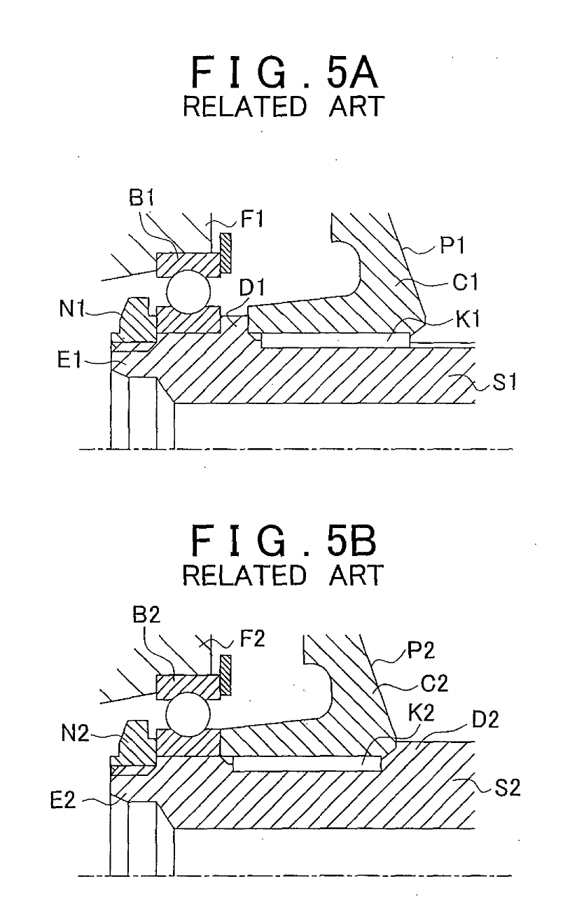

### DETAILED DESCRIPTION OF AN EMBODIMENT

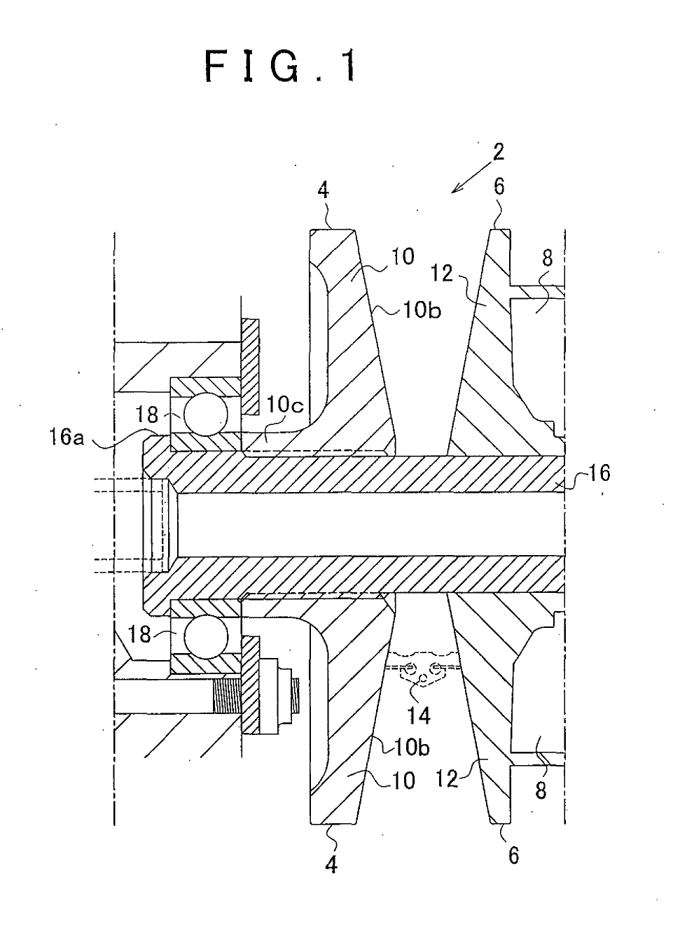

The vertical cross-sectional view of FIG. 1 shows the configuration of a principal part of a secondary sheave (which is also referred to as “secondary pulley”) 2 of a continuously variable transmission to which the invention is applied. The secondary sheave 2 has a stationary sheave half 4 and a movable sheave half 6. In the secondary sheave 2, the distance between a sheave portion 10 of the stationary sheave half 4 and a sheave portion 12 of the movable sheave half 6 is adjusted by an actuator 8 disposed behind the movable sheave half 6 and using hydraulic pressure or the like. The effective radius of the secondary sheave 2 is therefore controlled, whereby the radial contact positions of an endless belt 14 on the secondary sheave 2 and the primary sheave (which is also referred to as “primary pulley”) are changed to change the transmission speed ratio.

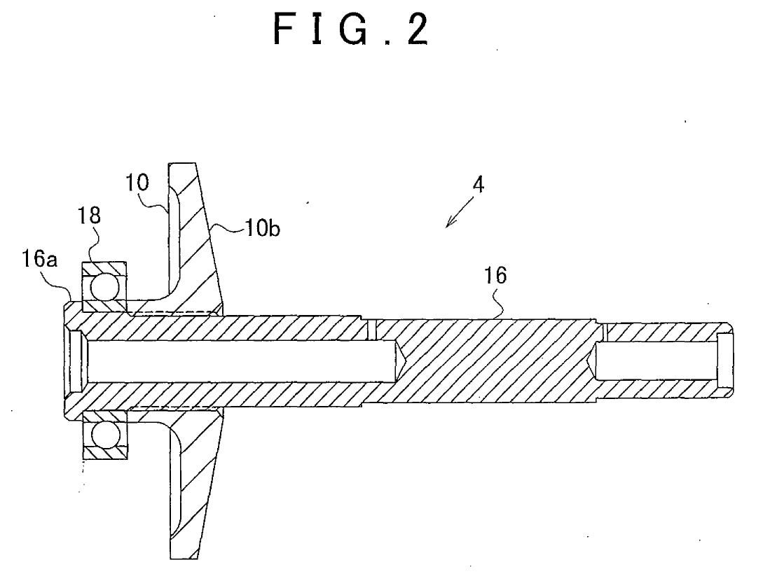

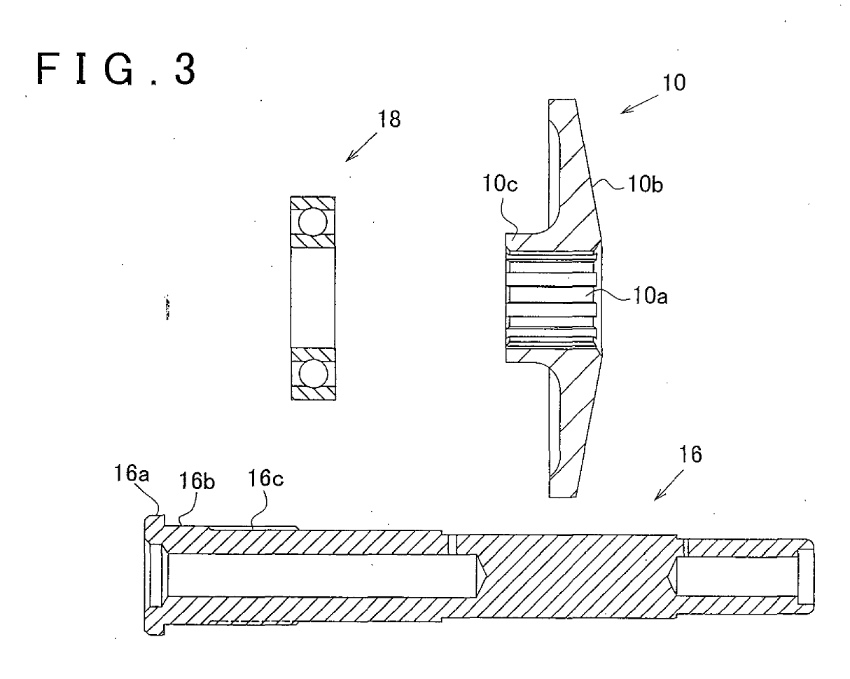

The stationary sheave half 4 is formed by combining and integrating the sheave portion 10, a shaft 16 and a ball bearing 18 as shown in the cross-sectional view of FIG. 2. The sheave portion 10, the shaft 16 and the ball bearing 18 are formed as separate parts as shown in FIG. 3.

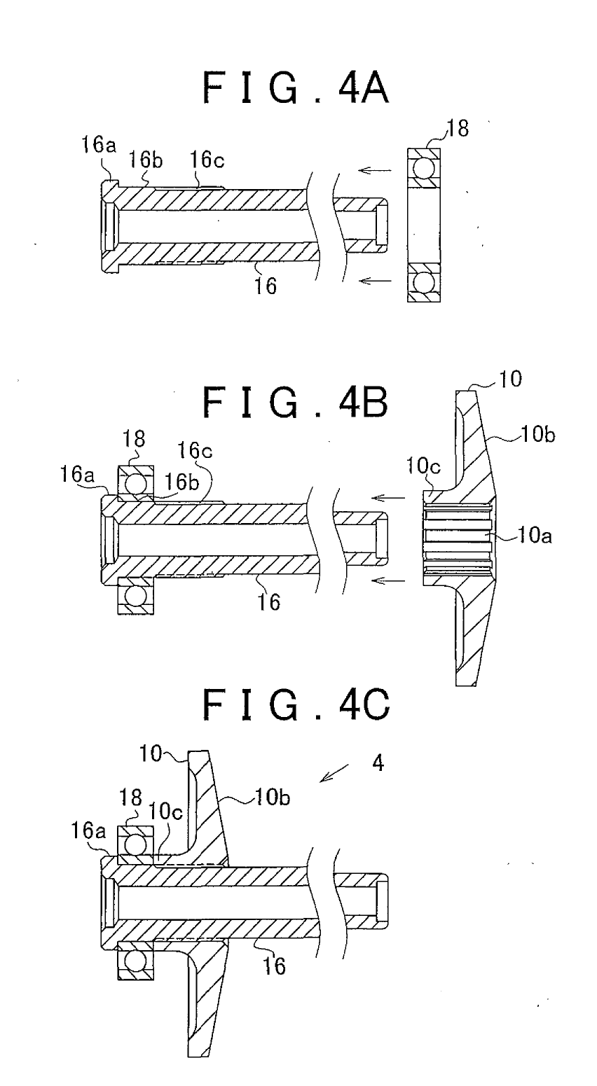

The process of integrating the sheave portion 10, the shaft 16 and the ball bearing 18 is shown in FIG. 4. First, as shown in FIG. 4A, the ball bearing 18 is slid onto the shaft 16 from a second end (right end in the drawing) of the shaft 16 toward a first end (left end in the drawing) thereof, until it abuts against a step portion 16a formed at the first end of the shaft 16, and fitted on a bearing fitting portion 16b formed adjacent to the flange 16a by press-fitting or other suitable method. The state of the shaft 16 with the ball bearing 18 fitted thereon is shown in FIG. 4B.

Next, as shown in FIG. 4B, the sheave portion 10 is slid onto the sheave portion fixing portion 16c from the second end until an end 10c thereof (the end in the direction of the thrust force from a sheave face 10b) abuts against the ball bearing 18 and fixed on a sheave portion fixing portion 16c.

The sheave portion 10 is press-fitted onto the sheave portion fixing portion 16c. Specifically the tooth flanks of the shaft 16, which are formed larger than tooth flanks of the sheave portion 10, are press fitted into the sheave portion 10. That is, splines are formed both in a center hole 10a of the sheave portion 10 and on the sheave portion fixing portion 16c, and the sheave portion fixing portion 16c is press-fitted into the center hole 10a with the ridges and grooves of the splines interlocked with each other. The sheave portion 10 is therefore fixed on the shaft 16 firmly enough to ensure sufficient transmission of torque, particularly in the rotational direction. Alternatively, knurls may be formed either on the sheave portion fixing portion 16c or in the center hole 10a of the sheave portion 10 so that they can be firmly fixed when the sheave portion fixing portion 16c is press-fitted into the center hole 10a of the sheave portion 10.

As a result, the stationary sheave half 4 as shown in FIG. 4C is obtained. When the stationary sheave half 4 is incorporated in a continuously variable transmission as the secondary sheave 2, the configuration shown in FIG. 1 is achieved.

According to the embodiment described above, the following effects may be obtained.

(i) The shaft 16 constituting the stationary sheave half 4 has the flange 16a, by which the axial position of the ball bearing 18 fitted on the bearing fitting portion 16b can be determined. The fixing of the position of the ball bearing 18 is achieved, when the shaft 16 and the sheave portion 10 are integrated, by fixing the sheave portion 10 on the sheave portion fixing portion 16c with the ball bearing 18 sandwiched between the flange 16a and the sheave portion 10.

Because the shaft 16 has one flange 16a and no threaded portion, and the ball bearing 18 is be fixed on the shaft 16 when the shaft 16 and the sheave portion 10 are integrated, the axial dimension of the stationary sheave half 4 of the secondary sheave may be reduced.

In addition, the thrust force exerted on the sheave portion 10 by the endless belt 14 acts toward the contact faces of the ball bearing 18 and the sheave portion 10. However, the flange 16a lies on the other side of the ball bearing 18. Therefore, even if the thrust force is transmitted to the flange 16a via the ball bearing 18, because of the contact of the end 10c in the direction of the thrust force with the ball bearing 18, the flange 16a will not loosen like nuts may. Thus, the structural integrity of the stationary sheave half 4 may be maintained.

(ii) To produce the stationary sheave half 4 for a continuously variable transmission, the ball bearing 18 is first slid onto the shaft 16 from the end opposite the flange 16a and fitted in a position where it abuts against the flange 16a. Then, the sheave portion 10 is slid onto the sheave portion fixing portion 16c until the end 10c in the direction of the thrust force from the sheave face 10b abuts against the ball bearing 18 and fixed on the sheave portion fixing portion 16c by press-fitting.

The sheave portion 10 may be easily integrated with the separately-formed shaft 16 together with the ball bearing 18 according to the above procedure. Therefore, both the shaft 16 and the sheave portion 10 may be easily produced and easily integrated with each other. As a result, the stationary sheave half 4 with a high manufacturability is realized.

In addition, the fixing of the sheave portion 10 is press-fitted onto the shaft 16. This method of fixing makes it easier to fix the sheave portion 10 in contact with the ball bearing 18. As a result, a smaller integrally-constructed stationary sheave half 4 may be easily produced.

(iii) By incorporating the stationary sheave half 4 in a continuously variable transmission, the overall length of the continuously variable transmission may be reduced. This contributes to size and weight reduction of the vehicle that is equipped with the continuously variable transmission.

(iv) Because there is no need for a threaded portion, there is no need to fasten a nut and therefore the stationary sheave half 4 for a continuously variable transmission may be assembled efficiently.

While the invention has been described with reference to example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

Although the sheave portion 10 is fixed to the sheave portion fixing portion 16c of the shaft 16 by press-fitting in the above embodiment, a method other than press-fitting, such as welding or connection using projections and recesses, that is, spline fitting, may also be used. In addition, the sheave portion 10 adjoin the ball bearing 18, and the stationary sheave half 4 for a continuously variable transmission may be easily produced.

1. A shaft of a belt-type continuously variable transmission integrated with the sheave portion together with a bearing to form a stationary sheave half for a continuously variable transmission, the shaft comprising:
a flange formed at one end of the shaft which has a larger diameter than the other part of the shaft;
a bearing fitting portion adjoining the flange that receives the bearing thereon; and
a sheave portion fixing portion, adjoining the bearing fitting portion, that fixes the sheave portion to the shaft at a center hole thereof.

2. The shaft of a belt-type continuously variable transmission according to claim 1, wherein the sheave portion is fixed to the sheave portion fixing portion by press-fitting.

3. The shaft of a belt-type continuously variable transmission according to claim 1, wherein the sheave portion is fixed to the sheave portion fixing portion by press-fitting tooth flanks of the shaft, which are formed larger than tooth flanks of the sheave portion, into the sheave portion.

4. The shaft of a belt-type continuously variable transmission according to claim 1, wherein the sheave portion is welded to the sheave portion fixing portion.

5. The shaft of a belt-type continuously variable transmission according to claim 1, wherein the sheave portion fixing portion is a portion on which the sheave portion is fixed by spline fitting.

6. The shaft of a belt-type continuously variable transmission according to claim 1, wherein the bearing abuts against the flange.

7. The shaft of a belt-type continuously variable transmission according to claim 1, wherein the bearing is a ball bearing.

8. The shaft of a belt-type continuously variable transmission according to claim 1, wherein the shaft constitutes a secondary sheave of a continuously variable transmission.

9. A stationary sheave half for a continuously variable transmission, by comprising:
the shaft of a belt-type continuously variable transmission according to claim 1;
a bearing that adjoins the flange of the shaft on the bearing fitting portion of the shaft; and
a sheave portion fixed on the sheave portion fixing portion of the shaft while an end thereof, in the direction of thrust force from the sheave face, in contact with the bearing.

10. A method for the production of a stationary sheave half for a continuously variable transmission, comprising:
sliding the bearing and the sheave portion sequentially onto the shaft according to claim 1 from the end opposite from the flange;
fitting the bearing in contact with the flange on the bearing fitting portion; and
fixing the sheave portion on the sheave portion fixing portion while an end thereof, in the direction which the thrust force acts from the sheave face, in contact with the bearing.

11. A continuously variable transmission comprising the stationary sheave half for a continuously variable transmission according to claim 9.
